(19) United States
(12) Patent Application Publication
(10) Pub. No.: US 2026/0281620 A1
(43) Pub. Date: Sep. 17, 2026

(54) DEVICE DESIGNATION OF PLAYBACK AND NETWORK MICROPHONE DEVICE ARRANGEMENTS

(71) Applicant: Sonos, Inc., Goleta, CA (US)

(72) Inventors: Sein Woo, Santa Barbara, CA (US); Andrew Lindley, Santa Barbara, CA (US); Ryan Myers, Santa Barbara, CA (US)

(21) Appl. No.: 19/430,086

(22) Filed: Dec. 22, 2025

Related U.S. Application Data
(63) Continuation of application No. 18/338,996, filed on Jun. 21, 2023, now Pat. No. 12,513,466.
Application No. 18/338,996 is a continuation of application No. 17/664,556, filed on May 23, 2022, now Pat. No. 11,689,858.
Application No. 17/664,556 is a continuation of application No. 16/966,397, filed on Jan. 31, 2019, now Pat. No. 11,343,614.
(60) Provisional application No. 62/624,779, filed on Jan. 31, 2018.

(51) Int. Cl. H04R 5/04; G06F 3/0481; G06F 3/04883; G06F 3/16; G10L 15/22; H04R 1/40; H04R 3/00; H04R 3/12; H04R 5/02; H04R 27/00; H04S 3/00

(52) U.S. Cl. CPC H04R 5/04; G06F 3/0481; G06F 3/04883; G06F 3/165; G06F 3/167; G10L 15/22; H04R 1/403; H04R 1/406; H04R 3/005; H04R 3/12; H04R 5/02; H04R 27/00; H04S 3/008; G10L 2015/223; H04R 2227/003; H04R 2227/005; H04R 2420/07; H04S 2400/01

(57) ABSTRACT

Example techniques relate to device spaces and default designations in a media playback system. A device space may create an association between a networked microphone device and one or more playback devices such that certain voice commands (e.g., playback commands) received by the networked microphone device are used to control the one or more playback devices (unless otherwise designated in the voice command). Furthermore, in bonded pairs and bonded groups of playback devices that include at least one NMD, certain playback devices within the bonded pair or group may be designated as default so as to avoid multiple responses to a voice input.

### CROSS-REFERENCE TO RELATED APPLICATIONS

This application is a continuation of U.S. patent application Ser. No. 18/338,996, filed Jun. 21, 2023, which is a continuation of U.S. patent application Ser. No. 17/664,556, filed May 23, 2022, now U.S. Pat. No. 11,689,858, issued on Jun. 27, 2023, which is a continuation of U.S. patent application Ser. No. 16/966,397, filed Jul. 30, 2020, now U.S. Pat. No. 11,343,614, issued May 24, 2022, which is a 371 National Phase of International Patent Application No. PCT/US2019/016166, filed Jan. 31, 2019, which claims the benefit of U.S. Provisional Patent Application No. 62/624,779, filed Jan. 31, 2018, which are incorporated herein by reference in their entireties.

### FIELD OF THE DISCLOSURE

The disclosure is related to consumer goods and, more particularly, to methods, systems, products, features, services, and other elements directed to voice control of media playback or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows a media playback system in which certain examples may be practiced;

FIG. 2A is a functional block diagram of an example playback device;

FIG. 2B is a isometric diagram of an example playback device that includes a network microphone device;

FIGS. 3A, 3B, 3C, 3D, and 3E are diagrams showing example zones and zone groups in accordance with aspects of the disclosure;

FIG. 4A is a functional block diagram of an example controller device in accordance with aspects of the disclosure;

FIGS. 4B and 4C are controller interfaces in accordance with aspects of the disclosure;

FIG. 5A is a functional block diagram of an example network microphone device in accordance with aspects of the disclosure;

FIG. 5B is a diagram of an example voice input in accordance with aspects of the disclosure;

FIG. 6 is a functional block diagram of example remote computing device(s) in accordance with aspects of the disclosure;

FIG. 7A is a schematic diagram of an example network system in accordance with aspects of the disclosure;

FIG. 7B is an example message flow implemented by the example network system of FIG. 7A in accordance with aspects of the disclosure;

FIG. 8A is an example method for setting up and configuring Device Spaces in a media playback system in accordance with aspects of the disclosure.

FIGS. 8B, 8C, 8D, 8E, and 8F show various examples of forming a Device Space comprising certain playback and network microphone devices shown in FIG. 1.

FIGS. 9A, 9B, 9C, 9D, and 9E show further examples of forming a Device Space comprising certain playback and network microphone devices in accordance with aspects of the disclosure.

FIGS. 10A, 10B, and 10C are diagrams showing example associations and designations of playback and network microphone devices within a media playback system;

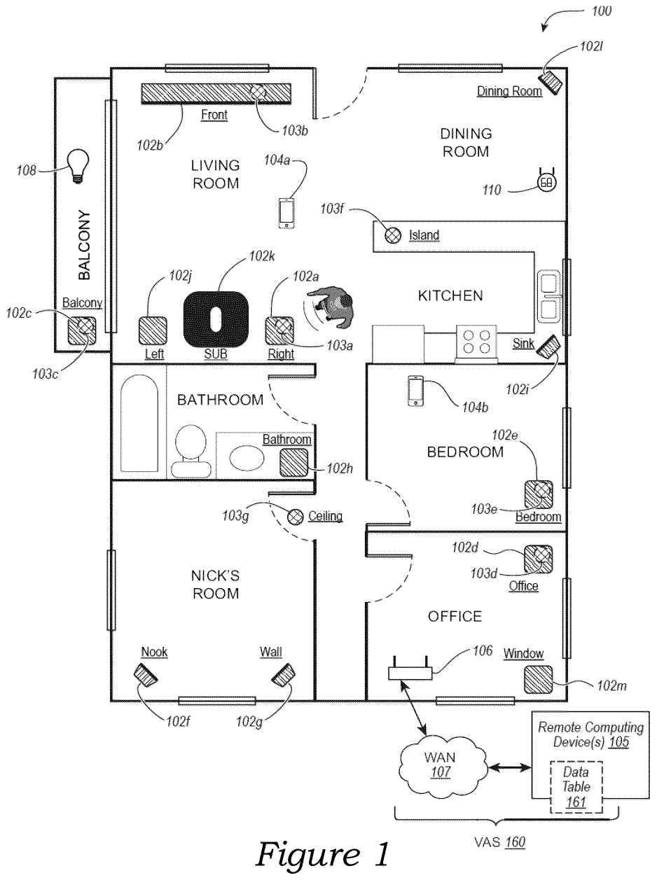

The drawings are for purposes of illustrating example embodiments, but it is understood that the inventions are not limited to the arrangements and instrumentalities shown in the drawings. In the drawings, identical reference numbers identify at least generally similar elements. To facilitate the discussion of any particular element, the most significant digit or digits of any reference number refers to the Figure in which that element is first introduced. For example, element 107 is first introduced and discussed with reference to FIG. 1.

### DETAILED DESCRIPTION

### I. Overview

Voice control can be beneficial for a “smart” home having smart appliances and related devices, such as wireless illumination devices, home-automation devices (e.g., thermostats, door locks, etc.), and audio playback devices. In some implementations, networked microphone devices may be used to control smart home devices. A network microphone device (NMD) will typically include a microphone for receiving voice inputs. The network microphone device can forward voice inputs to a voice assistant service (VAS). A traditional VAS may be a remote service implemented by cloud servers to process voice inputs. A VAS may process a voice input to determine an intent of the voice input. Based on the response, the NMD may cause one or more smart devices to perform an action. For example, the NMD may instruct an illumination device to turn on/off based on the response to the instruction from the VAS.

A voice input detected by an NMD will typically include a wake word followed by an utterance containing a user request. The wake word is typically a predetermined word or phrase used to “wake up” and invoke the VAS for interpreting the intent of the voice input. For instance, in querying the AMAZON® VAS, a user might speak the wake word “Alexa.” Other examples include “Ok, Google” for invoking the GOOGLE® VAS and “Hey, Siri” for invoking the APPLE® VAS, or “Hey, Sonos” for a VAS offered by SONOS®.

In operation, an NMD listens for a user request or command accompanying a wake word in the voice input. In some instances, the user request may include a command to control a third-party device, such as a thermostat (e.g., NEST® thermostat), an illumination device (e.g., a PHILIPS HUE® lighting device), or a media playback device (e.g., a Sonos® playback device). For example, a user might speak the wake word “Alexa” followed by the utterance “set the thermostat to 68 degrees” to set the temperature in a home using the Amazon® VAS. A user might speak the same wake word followed by the utterance “turn on the living room” to turn on illumination devices in a living room area of the home. The user may similarly speak a wake word followed by a request to play a particular song, an album, or a playlist of music on a playback device in the home.

In various examples described below, media playback systems may be configured to designate one or more default playback devices for an NMD. Designating a default playback device may be useful, for instance, in cases such as when a playback device does not include an onboard NMD, or a playback device is to play back audio in conjunction with an NMD, or a playback device is to play back audio in lieu of playback by the NMD. As an example, a user may speak a voice command to play a particular music track to an NMD that has had one or more default playback devices designated for that NMD. The spoken utterance of this command might not directly refer to the default playback device(s); however, the system identifies the default playback device(s) as a result of the default designation.

A possible benefit of such a default designation is that, in use, the default designation may simplify voice interactions. For instance, when the “Kitchen” device is designated as a default playback device for the NMD, the user may cause playback on the Kitchen device by speaking to the NMD a command to “play the Beatles on Spotify” rather than the more complex and lengthy command to “play the Beatles on Spotify in the Kitchen.” Examples for designating and applying default playback device designations are disclosed, for example, in U.S. application Ser. No. 15/438,749 filed Feb. 21, 2017, and titled “Voice Control of a Media Playback System,” which is incorporated herein in its entirety.

In some implementations, a user may desire to designate one or more default playback devices for one or more NMDs. For example, a user may have multiple playback and network microphone devices within a group or area and/or part of a bonded pair or bonded group of playback devices.

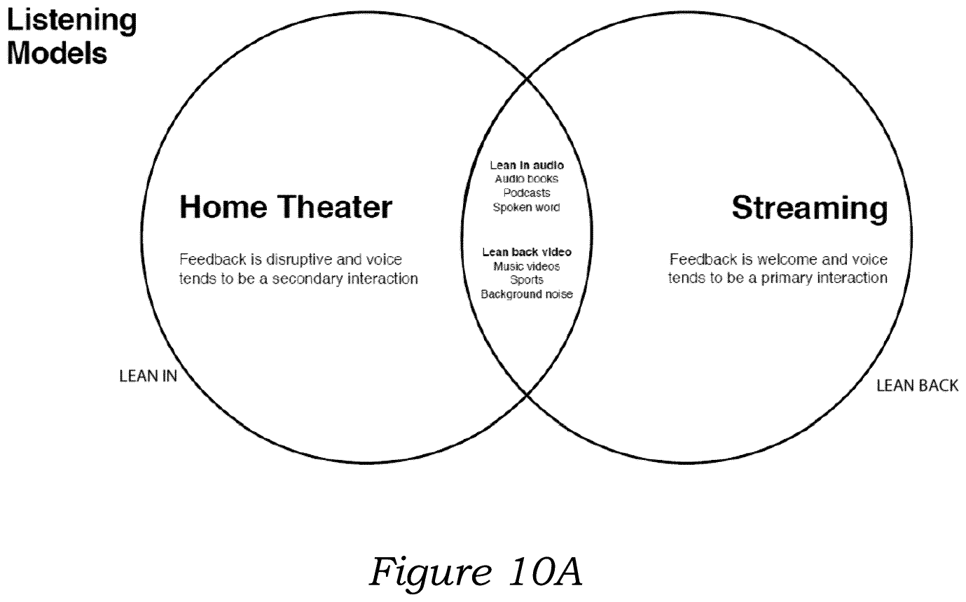

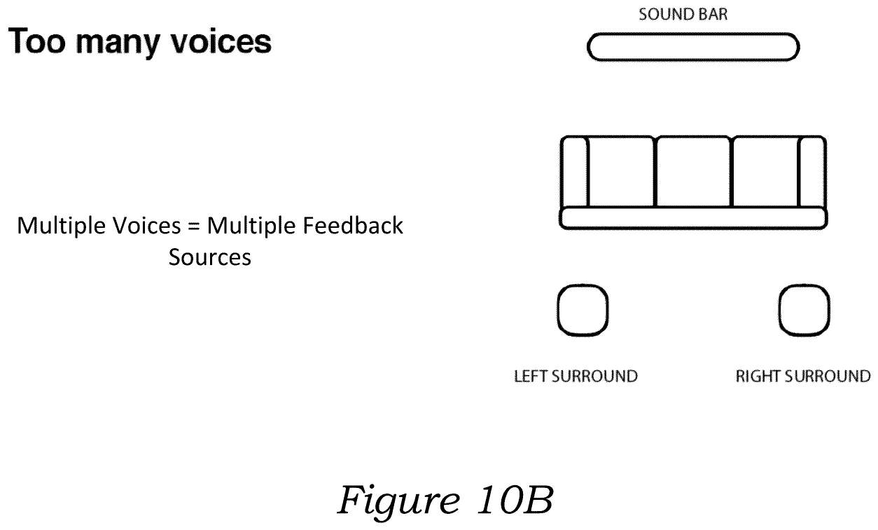

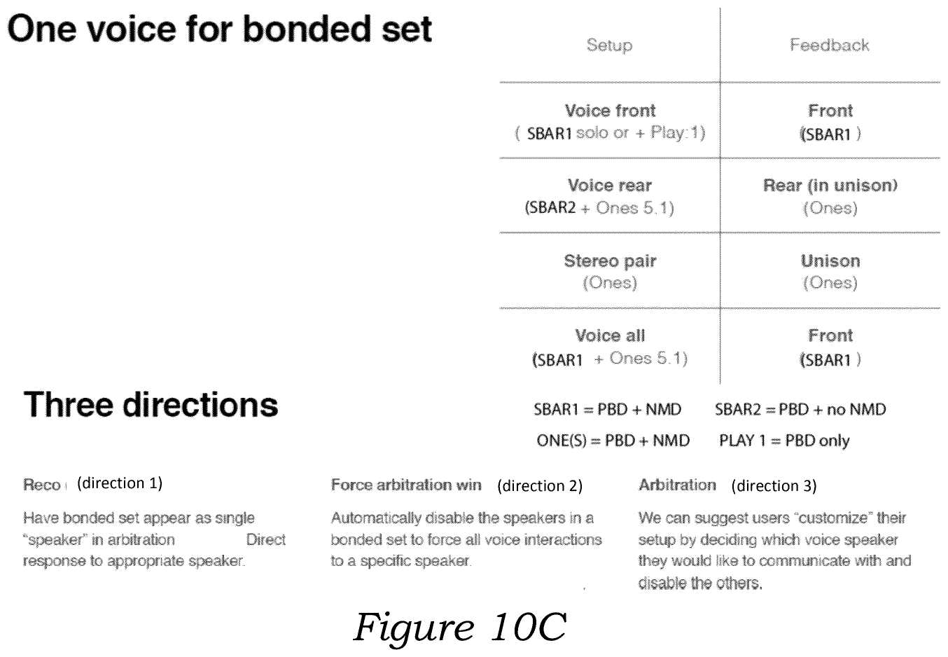

In one aspect of the various examples of the technology, a media playback system is configured to facilitate designating one or more default playback devices for one or more NMDs based on a desired listening model or mode. FIG. 10A shows example Lean In and Lean Back modes for a bonded group of devices, which include playback and network microphone devices. Referring to FIG. 10B, in one example, the playback and network microphone devices may include a left surround, a right surround, and a sound bar, any of which may be playback devices that include an NMD (i.e., by having the functionality of a NMD implemented as part of the device). In one example, all three of the devices may include an NMD. In other examples, only one or two of the surrounds and/or the sound bar may include an NMD (e.g., the left and right surrounds, the sound bar and one of the surrounds, or only one the left surround, the right surround, or the sound bar). Other examples are possible, including arrangements with a stand-alone NMD.

Referring to FIGS. 10A and 10B together, in Lean In mode, certain playback devices may be designated as default over others within a system when voice interaction with an NMD would tend to be considered a secondary priority. Voice interactions may be considered a secondary priority if such interactions would interfere with a user's listening experience. For example, feedback from an NMD may be particularly disruptive when a user is expected to be intently listening to audio content, such as while watching a movie. In some examples, only the most proximal device(s) to the user (e.g., one or both of the surrounds) in a bonded group may be designated as default playback devices in Lean In mode.

In Lean Back mode, by contrast, voice interaction may be more expected and considered primary priority. In some cases, streaming audio, such as audio books and podcasts, may be considered Lean In experiences in which voice interaction is secondary priority, while streaming background video, such as music videos and sports, may be considered Lean Back experiences in which voice interaction is primary priority.

In some examples, the media playback system can dynamically switch between listening models with minimal or no user intervention. For example, the listening mode may be detected and changed when a user switches a line-in source on/off, switches between line-in and a streaming content source (e.g., Spotify® or Audible®), or speaks a voice command to change from one pre-determined listening mode to another. In some examples, the system may switch from a Lean Back mode to Lean In when the user speaks a command that includes the phrase “lean in,” such as when watching movie or listening to an audio book. In a likewise fashion, the user may speak a command that includes the phrase “lean back” when the user turns on a news broadcast or plays background music. In some examples, the system may switch listening modes based on the streaming content source (e.g., Lean In if listening to audio from Audible® or Lean Back if listening to audio from Spotify®).

Within certain examples, in Lean In mode, additional and/or alternate playback devices may be designated as the default playback device(s). For example, a sound bar in a bonded grouping may be designated as a default playback device in Lean Back mode but not in Lean In mode. In some examples, default playback device designations in a bonded group may be based on whether or not a particular playback device in the group includes an onboard NMD. For example, the sound bar in FIG. 10B may be automatically recognized and designated as a default playback device of an NMD when (1) the NMD is on-board the sound bar and (2) neither of the surround devices includes an onboard NMD. The NMD of the sound bar in such a group may be temporarily disabled in Lean In mode to prevent voice interference until the sound bar is instructed to switch to Lean Back mode.

FIG. 10C shows a table illustrating example state information that may be used by a computing device to determine implementations in which playback devices are designated as default playback devices for NMDs during setup or when providing feedback. As shown, the implementations can be based on whether certain playback devices include or do not include an NMD. For example, a Sonos One includes an NMD while a Sonos Play:1 does not. In the former case, a sound bar that does not include an NMD may be designated as a default playback device in a bonded group with the Play:1's when in Lean Back mode, but not designated when in Lean In mode. FIG. 10C also shows additional considerations for designating default playback devices for NMDs.

In another aspect of the various examples of the technology, a media playback system is configured to facilitate setup of playback and network microphone devices by enabling a user to assign them to various “Device Spaces.” In general, a Device Space is a representation of a functional association between selected playback and network microphone devices in a media playback system. A Device Space may be stored in memory as a data structure, such as a data table containing associations and designations that can be accessed and invoked by a user. A Device Space may be visually presented to a user via, e.g., a display of a controller device, as described in greater detail below. In some examples, the method may involve setting up a Device Space in conjunction with a listening mode, as discussed above. In other examples, a Device Space might not be associated with a listening mode.

In some examples, a method for implementing Device Spaces may comprise (1) creating a first Device Space representing selected device associations in the media playback system, (2) removing the NMD from a second Device Space if the NMD belongs to the second Device Space and assigning the NMD to the first Device Space, (3) removing the at least one playback device from a third Device Space if the at least one playback device belongs to the third Device Space and assigning the at least one playback device to the first Device Space, and (4) designating the at least one playback device as a default playback device for the NMD in the first Device Space. In some examples, creating the first Device Space may comprise naming the first Device Space based on a name associated with the at least one playback device, a group of playback devices comprising the at least one playback device, or a bonded pair or bonded group of playback devices comprising the at least one playback device.

Assigning the NMD to the first Device Space may include triggering an indicator (light, chime, etc.) of the NMD. The indicator may audibly and/or visually alert the user as to which of the NMDs and/or playback devices is joining a particular Device Space while it is being created or updated by a user. Audible and/or visible alerts can help guide and ensure the user that the appropriate NMDs and playback devices are being placed into and/or removed from a Device Space, which may become increasingly difficult to map using a controller device alone if the user adds more devices, groupings, and pairings to a media playback system. For example, when there are multiple devices providing feedback, such feedback may lead to confusion and/or uncertainty as to the source of the feedback. Also, multiple NMDs in relatively close proximity to one another may inadvertently trigger each other due to limited echo cancellation.

While some examples described herein may refer to functions performed by given actors such as “users” and/or other entities, it should be understood that this description is for purposes of explanation only. The claims should not be interpreted to require action by any such example actor unless explicitly required by the language of the claims themselves.

### II. Example Operating Environment

FIG. 1 illustrates an example configuration of a media playback system 100 in which one or more examples disclosed herein may be implemented. The media playback system 100 as shown is associated with an example home environment having several rooms and spaces, such as for example, an office, a dining room, and a living room. Within these rooms and spaces, the media playback system 100 includes playback devices 102 (identified individually as playback devices 102a-102m), network microphone devices 103 (identified individually as “NMD(s)” 103a-103g), and controller devices 104a and 104b (collectively “controller devices 104”). The home environment may include other network devices, such as one or more smart illumination devices 108 and a smart thermostat 110.

The various playback, network microphone, and controller devices 102-104 and/or other network devices of the media playback system 100 may be coupled to one another via point-to-point connections and/or over other connections, which may be wired and/or wireless, via a LAN including a network router 106. For example, the playback device 102j (designated as “Left”) may have a point-to-point connection with the playback device 102a (designated as “Right”). In one example, the Left playback device 102j may communicate over the point-to-point connection with the Right playback device 102a. In a related example, the Left playback device 102j may communicate with other network devices via the point-to-point connection and/or other connections via the LAN. In some examples, the Right playback device 102a, the Left playback device 102j, and/or the Front playback device 102b may be assigned as NMDs and/or designated as default playback devices depending on the operating mode of the playback devices, such as whether these devices are operating in Lean In or Lean Back mode, as discussed above.

The network router 106 may be coupled to one or more remote computing device(s) 105 via a wide area network (WAN) 107. In some examples, the remote computing device(s) may be cloud servers. The remote computing device(s) 105 may be configured to interact with the media playback system 100 in various ways. For example, the remote computing device(s) may be configured to facilitate streaming and controlling playback of media content, such as audio, in the home environment. In one aspect of the technology described in greater detail below, the remote computing device(s) 105 are configured to provide a first VAS 160 for the media playback system 100.

In some examples, one or more remote computing devices, such as a remote computing device of the first VAS 160, may maintain information corresponding to default playback device designations in a data table 161 or related data structure. The data table 161 may include, for example, data associated with the table shown in FIG. 10C for enabling certain listening modes. The data table 161 may also store information corresponding to a Device Space to which one or more playback and network devices have been assigned, as described above and in greater detail below. In some examples, the data table 161 may be maintained at least in part by a computing device of the media playback system 100, such as by one of the playback devices 102, network microphone devices 103, controllers 104, and/or other computing devices on the LAN.

In some examples, one or more of the playback devices 102 may include an on-board (e.g., integrated) network microphone device. For example, the playback devices 102a-e include corresponding NMDs 103a-e, respectively. Playback devices that include network microphone devices may be referred to herein interchangeably as a playback device or a network microphone device unless indicated otherwise in the description.

In some examples, one or more of the NMDs 103 may be a stand-alone device. For example, the NMDs 103f and 103g may be stand-alone network microphone devices. A stand-alone network microphone device may omit components typically included in a playback device, such as a speaker or related electronics. In such cases, a stand-alone network microphone device may not produce audio output or may produce limited audio output (e.g., relatively low-quality audio output compared to a playback device).

In use, a network microphone device may receive and process voice inputs from a user in its vicinity. For example, a network microphone device may capture a voice input upon detection of the user speaking the input. In the illustrated example, the NMD 103a of the playback device 102a in the Living Room may capture the voice input of a user in its vicinity. In some instances, other network microphone devices (e.g., the NMDs 103b and 103f) in the vicinity of the voice input source (e.g., the user) may also detect the voice input. In such instances, network microphone devices may arbitrate between one another to determine which device(s) should capture and/or process the detected voice input. Examples for selecting and arbitrating between network microphone devices may be found, for example, in previously referenced U.S. application Ser. No. 15/438,749

In certain examples, a network microphone device may be assigned to a playback device that may not include a network microphone device. For example, the NMD 103f may be assigned to the playback devices 102i and/or 102l in its vicinity. In a related example, a network microphone device may output audio through a playback device to which it is assigned. Additional details regarding associating network microphone devices and playback devices as designated or default devices may be found, for example, in previously referenced U.S. patent application Ser. No. 15/438,749.

Further aspects relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in other home environment configurations comprising more or fewer of any of the playback, network microphone, and/or controller devices 102-104. Additionally, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

a. Example Playback and Network Microphone Devices

By way of illustration, SONOS, Inc. presently offers (or has offered) for sale certain playback devices including a “PLAY:1,” “SONOS ONE” “PLAY:3,” “PLAY:5,” “PLAYBAR,” “PLAYBASE,” “CONNECT:AMP,” “CONNECT,” and “SUB.” Any other past, present, and/or future playback devices may additionally or alternatively be used to implement the playback devices of example examples disclosed herein. Additionally, it is understood that a playback device is not limited to the examples shown and described herein or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

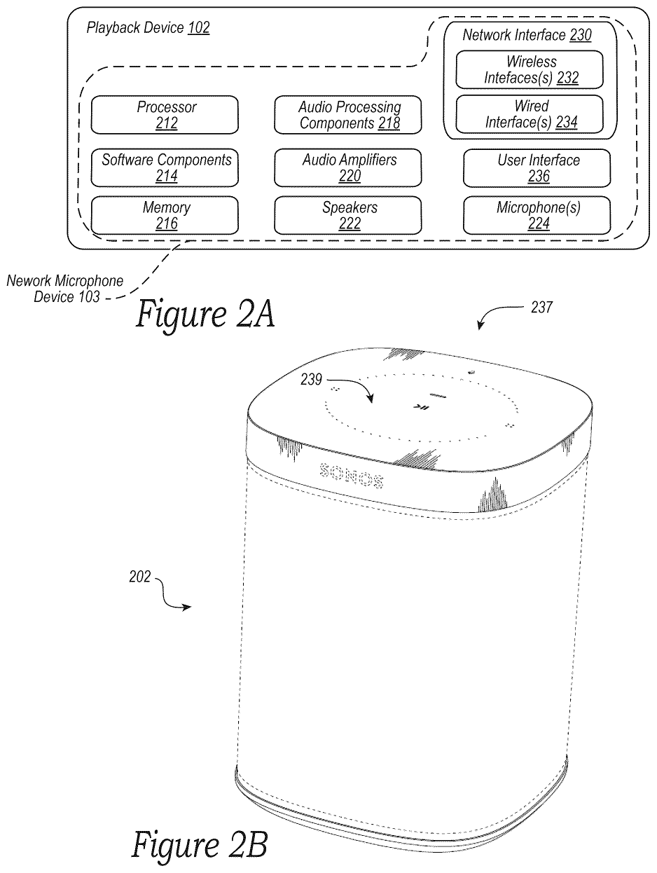

FIG. 2A is a functional block diagram illustrating certain aspects of a selected one of the playback devices 102 shown in FIG. 1. As shown, such a playback device may include a processor 212, software components 214, memory 216, audio processing components 218, audio amplifier(s) 220, speaker(s) 222, and a network interface 230 including wireless interface(s) 232 and wired interface(s) 234. In some examples, a playback device may not include the speaker(s) 222, but rather a speaker interface for connecting the playback device to external speakers. In certain examples, the playback device may include neither the speaker(s) 222 nor the audio amplifier(s) 222, but rather an audio interface for connecting a playback device to an external audio amplifier or audio-visual receiver.

A playback device may further include a user interface 236. The user interface 236 may facilitate user interactions independent of or in conjunction with one or more of the controller devices 104. In various examples, the user interface 236 includes one or more of physical buttons and/or graphical interfaces provided on touch sensitive screen(s) and/or surface(s), among other possibilities, for a user to directly provide input. The user interface 236 may further include one or more of lights and the speaker(s) to provide visual and/or audio feedback to a user.

In some examples, the processor 212 may be a clock-driven computing component configured to process input data according to instructions stored in the memory 216. The memory 216 may be a tangible computer-readable medium configured to store instructions executable by the processor 212. For example, the memory 216 may be data storage that can be loaded with one or more of the software components 214 executable by the processor 212 to achieve certain functions. In one example, the functions may involve a playback device retrieving audio data from an audio source or another playback device. In another example, the functions may involve a playback device sending audio data to another device on a network. In yet another example, the functions may involve pairing of a playback device with one or more other playback devices to create a multi-channel audio environment.

Certain functions may include or otherwise involve a playback device synchronizing playback of audio content with one or more other playback devices. During synchronous playback, a listener may not perceive time-delay differences between playback of the audio content by the synchronized playback devices. U.S. Pat. No. 8,234,395 filed Apr. 4, 2004, and titled “System and method for synchronizing operations among a plurality of independently clocked digital data processing devices,” which is hereby incorporated by reference in its entirety, provides in more detail some examples for audio playback synchronization among playback devices.

The audio processing components 218 may include one or more digital-to-analog converters (DAC), an audio preprocessing component, an audio enhancement component or a digital signal processor (DSP), and so on. In some examples, one or more of the audio processing components 218 may be a subcomponent of the processor 212. In one example, audio content may be processed and/or intentionally altered by the audio processing components 218 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback, the audio processing components 208 may be configured to process audio content to be sent to one or more other playback devices for playback.

Audio content to be processed and/or played back by a playback device may be received from an external source, such as via an audio line-in input connection (e.g., an auto-detecting 3.5 mm audio line-in connection) or the network interface 230.

The network interface 230 may be configured to facilitate a data flow between a playback device and one or more other devices on a data network. As such, a playback device may be configured to receive audio content over the data network from one or more other playback devices in communication with a playback device, network devices within a local area network, or audio content sources over a wide area network such as the Internet. In one example, the audio content and other signals transmitted and received by a playback device may be transmitted in the form of digital packet data containing an Internet Protocol (IP)-based source address and IP-based destination addresses. In such a case, the network interface 230 may be configured to parse the digital packet data such that the data destined for a playback device is properly received and processed by the playback device.

As shown, the network interface 230 may include wireless interface(s) 232 and wired interface(s) 234. The wireless interface(s) 232 may provide network interface functions for a playback device to wirelessly communicate with other devices (e.g., other playback device(s), speaker(s), receiver(s), network device(s), control device(s) within a data network the playback device is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 234 may provide network interface functions for a playback device to communicate over a wired connection with other devices in accordance with a communication protocol (e.g., IEEE 802.3). While the network interface 230 shown in FIG. 2A includes both wireless interface(s) 232 and wired interface(s) 234, the network interface 230 may in some examples include only wireless interface(s) or only wired interface(s).

As discussed above, a playback device may include a network microphone device, such as one of the NMDs 103 shown in FIG. 1. A network microphone device may share some or all the components of a playback device, such as the processor 212, the memory 216, the microphone(s) 224, etc. In other examples, a network microphone device includes components that are dedicated exclusively to operational aspects of the network microphone device. For example, a network microphone device may include far-field microphones and/or voice processing components, which in some instances a playback device may not include. But in some examples, a playback device may contain the same or similar far-field microphones and/or voice processing components as a network microphone device, thereby enabling the playback device to function as a networked microphone device. In another example, a network microphone device may include a touch-sensitive button for enabling/disabling a microphone.

FIG. 2B is an isometric diagram showing an example playback device 202 incorporating a network microphone device (NMD). The playback device 202 has a control area 237 at the top of the device comprising a switch 238 to turn the microphones “on” and/or “off” via a manual control input, e.g., the user touches the switch 238 to toggle the microphones on/off. The control area 237 is adjacent to another area 239 at the top of the playback device 202 for controlling playback. In some examples, switch 238 functions as a hard-kill switch. A hard-kill switch differs from a soft-kill switch by physically disconnecting from power or otherwise mechanically deactivating the microphone(s) of the NMD. A hard-kill switch cannot be functionally toggled or controlled in software remotely. Such a hard-kill feature assures the user that the microphones cannot be activated inadvertently by a user or others, or surreptitiously or otherwise by others, because the hard-kill switch completely disconnects power from the microphones of the NMD.

b. Example Playback Device Configurations

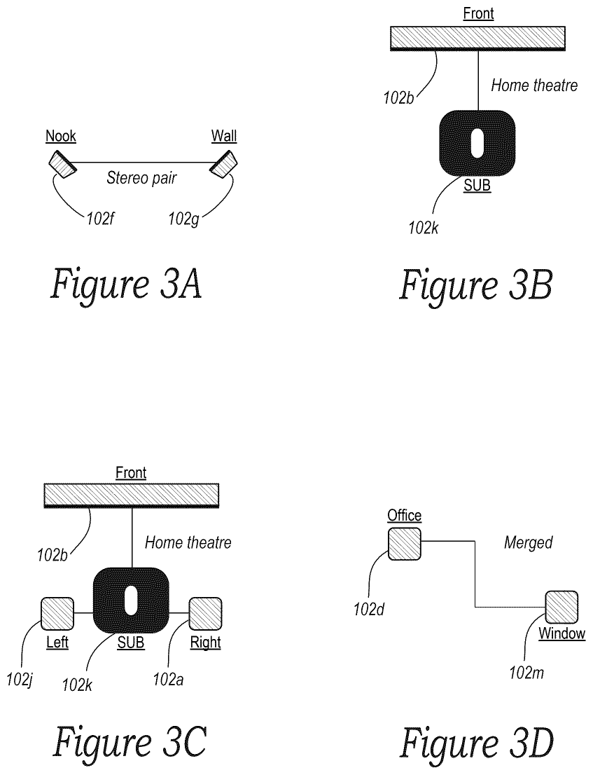

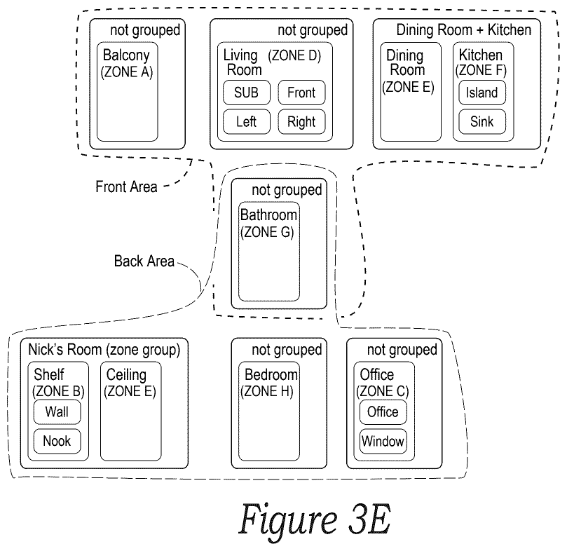

FIGS. 3A-3E show example configurations of playback devices in zones and zone groups. Referring first to FIG. 3E, in one example, a single playback device may belong to a zone. For example, the playback device 102c in the Balcony may belong to Zone A. In some implementations described below, multiple playback devices may be “bonded” to form a “bonded pair” which together form a single zone. For example, the playback device 102f named Nook in FIG. 1 may be bonded to the playback device 102g named Wall to form Zone B. Bonded playback devices may have different playback responsibilities (e.g., channel responsibilities). In another implementation described below, multiple playback devices may be merged to form a single zone. For example, the playback device 102d named Office may be merged with the playback device 102m named Window to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

Each zone in the media playback system 100 may be provided for control as a single user interface (UI) entity. For example, Zone A may be provided as a single entity named Balcony. Zone C may be provided as a single entity named Office. Zone B may be provided as a single entity named Shelf.

In various examples, a zone may take on the name of one of the playback device(s) belonging to the zone. For example, Zone C may take on the name of the Office device 102d (as shown). In another example, Zone C may take on the name of the Window device 102m. In a further example, Zone C may take on a name that is some combination of the Office device 102d and Window device 102m. The name that is chosen may be selected by user. In some examples, a zone may be given a name that is different than the device(s) belonging to the zone. For example, Zone B is named Shelf but none of the devices in Zone B have this name.

Playback devices that are bonded may have different playback responsibilities, such as responsibilities for certain audio channels. For example, as shown in FIG. 3A, the Nook and Wall devices 102f and 102g may be bonded so as to produce or enhance a stereo effect of audio content. In this example, the Nook playback device 102f may be configured to play a left channel audio component, while the Wall playback device 102g may be configured to play a right channel audio component. In some implementations, such stereo bonding may be referred to as “pairing.”

Additionally, bonded playback devices may have additional and/or different respective speaker drivers. As shown in FIG. 3B, the playback device 102b named Front may be bonded with the playback device 102k named SUB. The Front device 102b may render a range of mid to high frequencies and the SUB device 102k may render low frequencies as, e.g., a subwoofer. When un-bonded, the Front device 102b may render a full range of frequencies. As another example, FIG. 3C shows the Front and SUB devices 102b and 102k further bonded with Right and Left playback devices 102a and 102k, respectively. In some implementations, the Right and Left devices 102a and 102k may form surround or “satellite” channels of a home theatre system. The bonded playback devices 102a, 102b, 102j, and 102k may form a single Zone D (FIG. 3E).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback device 102d and 102m in the Office have the single UI entity of Zone C. In one example, the playback devices 102d and 102m may each output the full range of audio content each respective playback device 102d and 102m are capable of, in synchrony.

In some examples, a stand-alone network microphone device may be in a zone by itself. For example, the NMD 103g in FIG. 1 named Ceiling may be Zone E. A network microphone device may also be bonded or merged with another device so as to form a zone. For example, the NMD device 103f named Island may be bonded with the playback device 102i Kitchen, which together form Zone G, which is also named Kitchen. Additional details regarding associating network microphone devices and playback devices as designated or default devices may be found, for example, in previously referenced U.S. patent application Ser. No. 15/438,749. In some examples, a stand-alone network microphone device may not be associated with a zone.

Zones of individual, bonded, and/or merged devices may be grouped to form a zone group. For example, referring to FIG. 3E, Zone A may be grouped with Zone B to form a zone group that includes the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group, such as Dining Room+Kitchen, as shown in FIG. 3E. In some examples, a zone group may be given a unique name selected by a user, such as Nick's Room, as also shown in FIG. 3E.

Referring again to FIG. 2A, certain data may be stored in the memory 216 as one or more state variables that are periodically updated and used to describe the state of a playback zone, the playback device(s), and/or a zone group associated therewith. The memory 216 may also include the data associated with the state of the other devices of the media system, and shared from time to time among the devices so that one or more of the devices have the most recent data associated with the system.

In some examples, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1, identifiers associated with the Balcony may indicate that the Balcony is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room +Kitchen group and that devices 103f and 102i are bonded. Identifiers associated with the Kitchen may indicate the same or similar information by virtue of the Kitchen being part of the Dining Room +Kitchen zone group. Other example zone variables and identifiers are described below.

In yet another example, the media playback system 100 may store and use variables or identifiers representing other associations of zones and zone groups, such as identifiers associated with Areas, as shown in FIG. 3. An area may involve a cluster of zone groups and/or zones not within a zone group. For instance, FIG. 3E shows a first area named Front Area and a second area named Back Area. The Front Area includes zones and zone groups of the Balcony, Living Room, Dining Room, Kitchen, and Bathroom. The Back Area includes zones and zone groups of the Bathroom, Nick's Room, the Bedroom, and the Office. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” U.S. application Ser. No. 15/682,506 and U.S. Pat. No. 8,483,853 are both incorporated herein by reference in their entirety. In some examples, the media playback system 100 may not implement Areas, in which case the system may not store variables associated with Areas.

The memory 216 may be further configured to store other data. Such data may pertain to audio sources accessible by a playback device or a playback queue that the playback device (or some other playback device(s)) may be associated with. In examples described below, the memory 216 is configured to store a set of command data for selecting a particular VAS, such as the first VAS 160, when processing voice inputs. The memory 216 may also be configured to store some or all of the information of the data table 161 associated with the default playback device designations.

During operation, one or more playback zones in the environment of FIG. 1 may each be playing different audio content. For instance, the user may be grilling in the Balcony zone and listening to hip hop music being played by the playback device 102c while another user may be preparing food in the Kitchen zone and listening to classical music being played by the playback device 102i. In another example, a playback zone may play the same audio content in synchrony with another playback zone. For instance, the user may be in the Office zone where the playback device 102d is playing the same hip-hop music that is being playing by playback device 102c in the Balcony zone. In such a case, playback devices 102c and 102d may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified. As such, the media playback system 100 may support numerous configurations. For example, if a user physically moves one or more playback devices to or from a zone, the media playback system 100 may be reconfigured to accommodate the change(s). For instance, if the user physically moves the playback device 102c from the Balcony zone to the Office zone, the Office zone may now include both the playback devices 102c and 102d. In some cases, the use may pair or group the moved playback device 102c with the Office zone and/or rename the players in the Office zone using, e.g., one of the controller devices 104 and/or voice input. As another example, if one or more playback devices 102 are moved to a particular area in the home environment that is not already a playback zone, the moved playback device(s) may be renamed or associated with a playback zone for the particular area.

Further, different playback zones of the media playback system 100 may be dynamically combined into zone groups or split up into individual playback zones. For example, the Dining Room zone and the Kitchen zone may be combined into a zone group for a dinner party such that playback devices 102i and 1021 may render audio content in synchrony. As another example, bonded playback devices 102 in the Living Room zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Living Room zone in such a manner may allow one user to listen to music in the listening zone in one area of the living room space, and another user to watch the television in another area of the living room space.

In a related example, a user may implement either of the NMD 103a or 103b to control the Living Room zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the media playback system 100.

c. Example Controller Devices

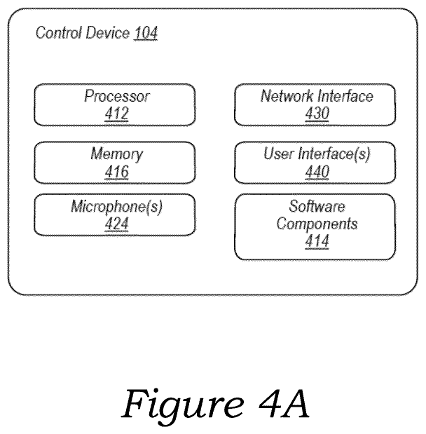

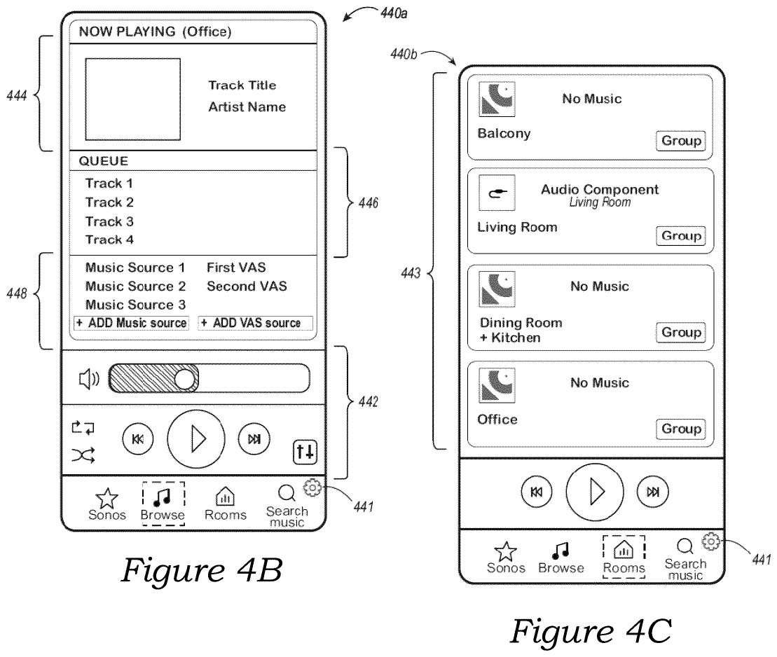

FIG. 4A is a functional block diagram illustrating certain aspects of a selected one of the controller devices 104 of the media playback system 100 of FIG. 1. Such controller devices may also be referred to as a controller. The controller device shown in FIG. 4A may include components that are generally similar to certain components of the network devices described above, such as a processor 412, memory 416, microphone(s) 424, and a network interface 430. In one example, a controller device may be a dedicated controller for the media playback system 100. In another example, a controller device may be a network device on which media playback system controller application software may be installed, such as for example, an iPhone™, iPad™ or any other smart phone, tablet or network device (e.g., a networked computer such as a PC or Mac™).

The memory 416 of a controller device may be configured to store controller application software and other data associated with the media playback system 100 and a user of the system 100. The memory 416 may be loaded with one or more software components 414 executable by the processor 412 to achieve certain functions, such as facilitating user access, control, and configuration of the media playback system 100. A controller device communicates with other network devices over the network interface 430, such as a wireless interface, as described above.

In one example, data and information (e.g., such as a state variable) may be communicated between a controller device and other devices via the network interface 430. For instance, playback zone and zone group configurations in the media playback system 100 may be received by a controller device from a playback device, a network microphone device, or another network device, or transmitted by the controller device to another playback device or network device via the network interface 406. In some cases, the other network device may be another controller device.

Playback device control commands such as volume control and audio playback control may also be communicated from a controller device to a playback device via the network interface 430. As suggested above, changes to configurations of the media playback system 100 may also be performed by a user using the controller device. The configuration changes may include adding/removing one or more playback devices to/from a zone, adding/removing one or more zones to/from a zone group, forming a bonded or merged player, separating one or more playback devices from a bonded or merged player, among others.

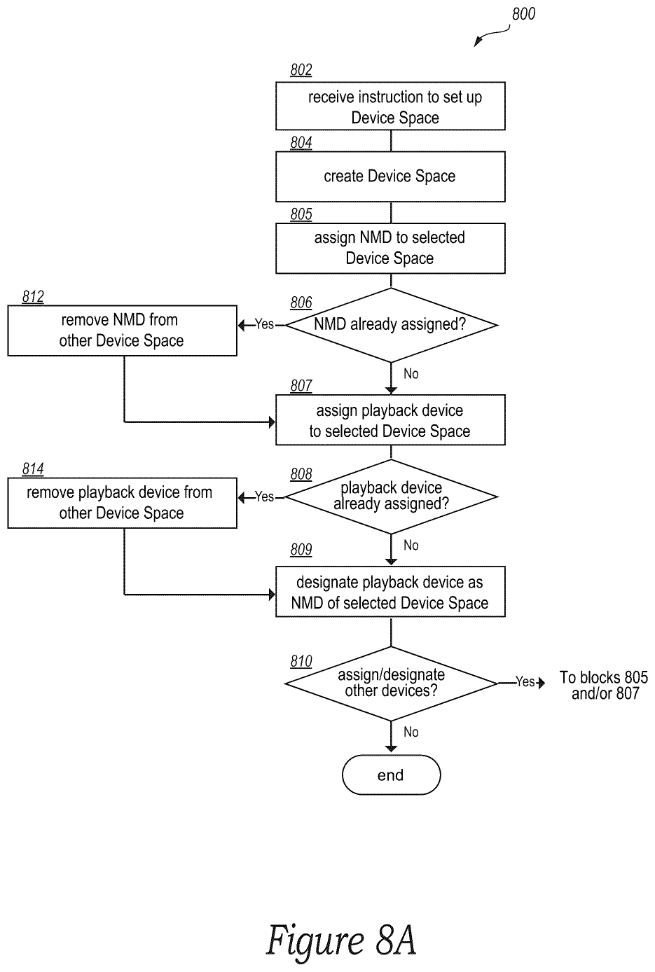

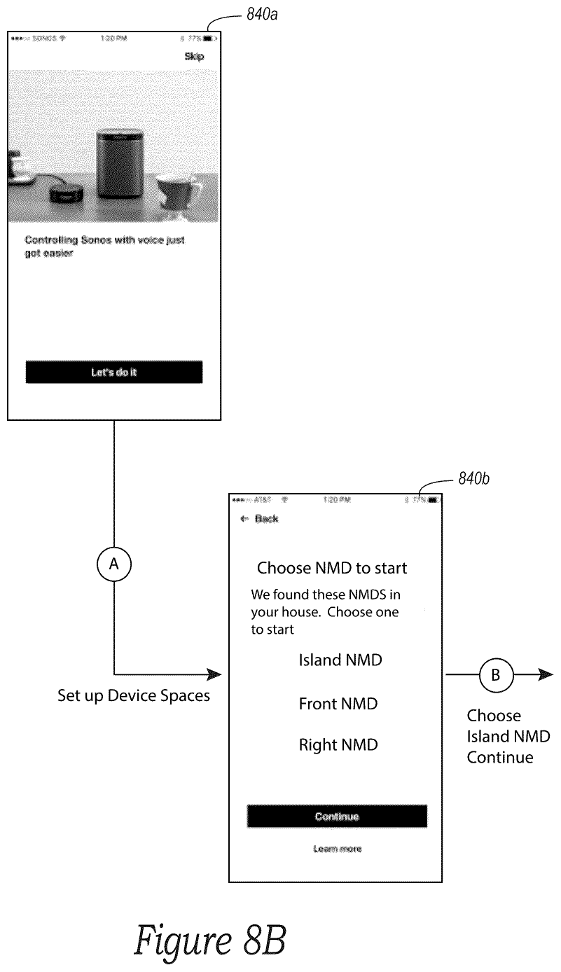

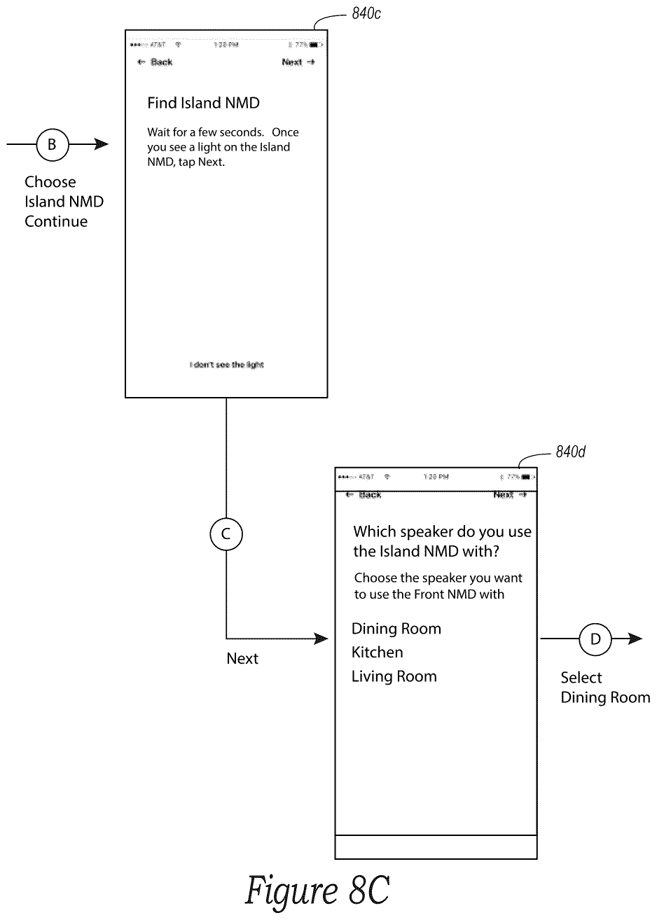

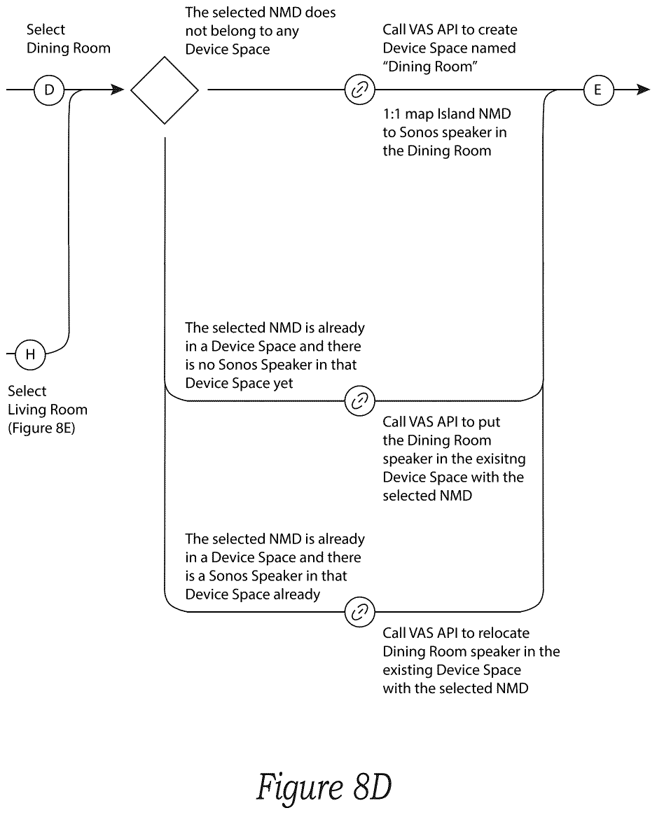

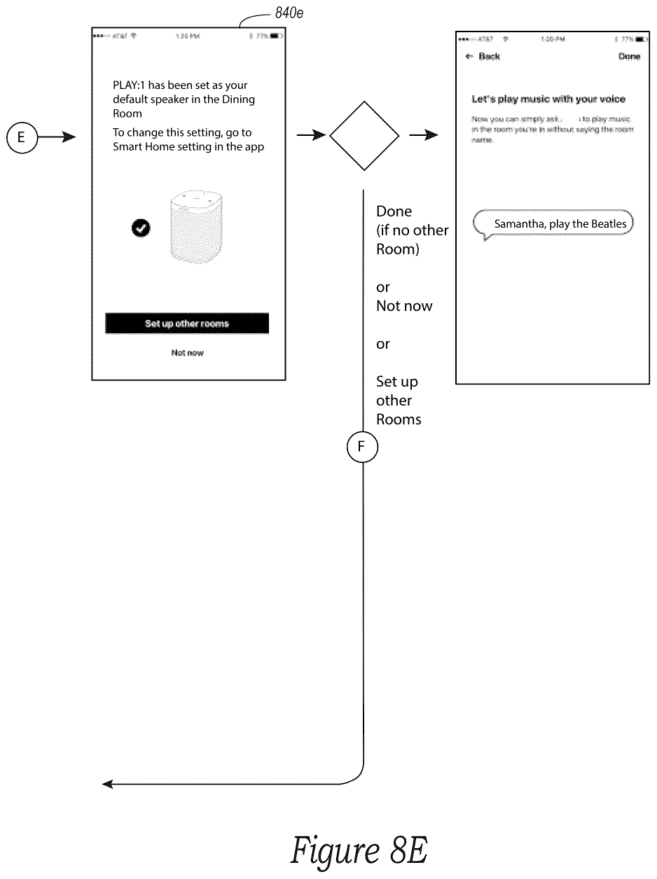

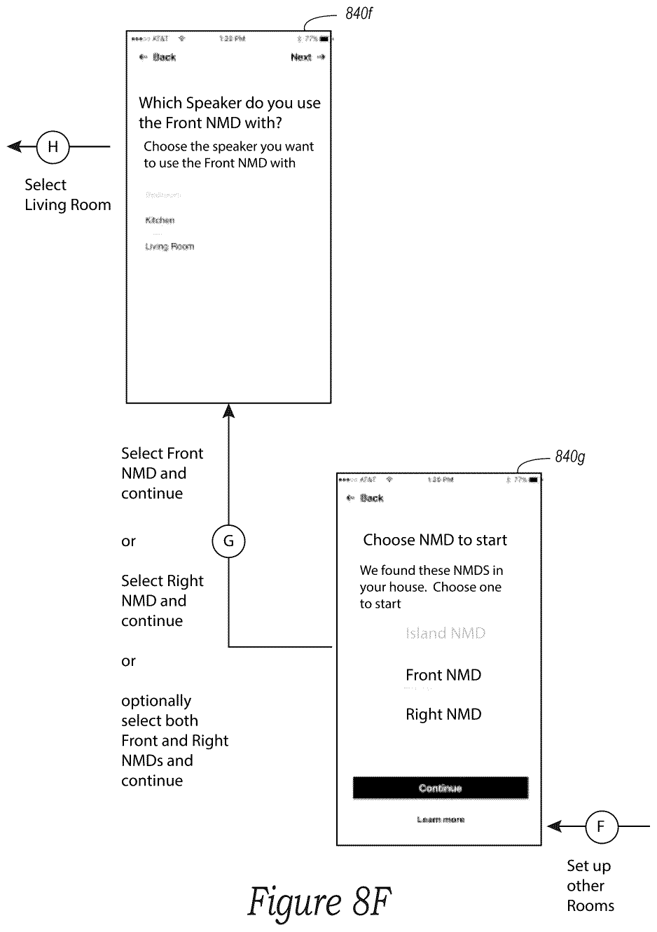

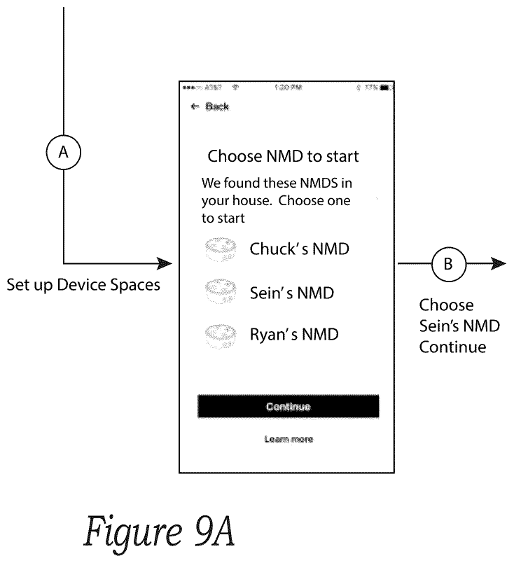

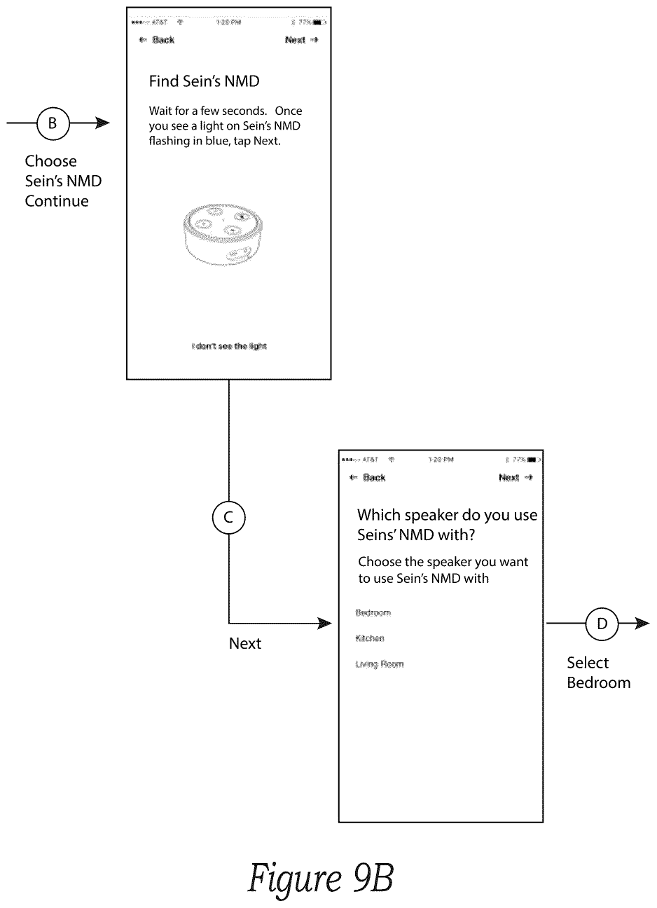

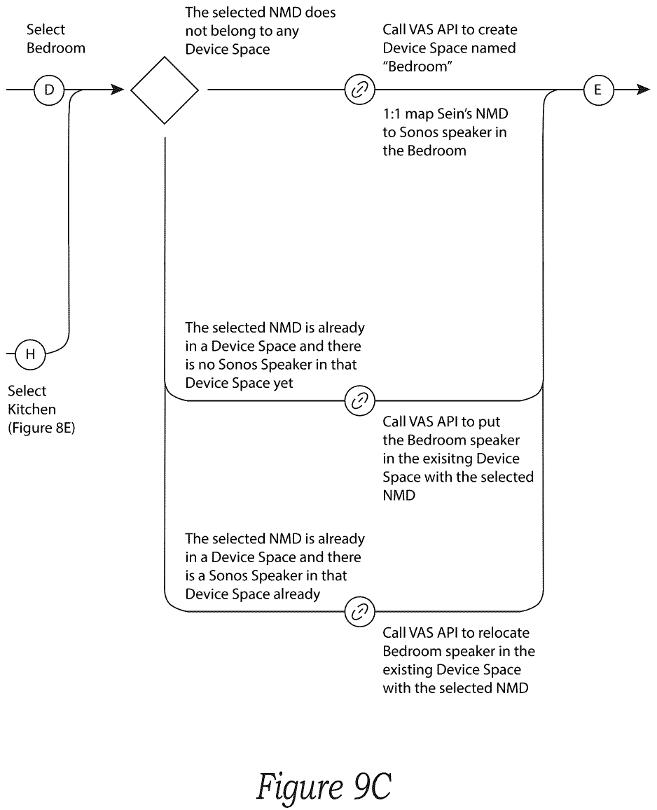

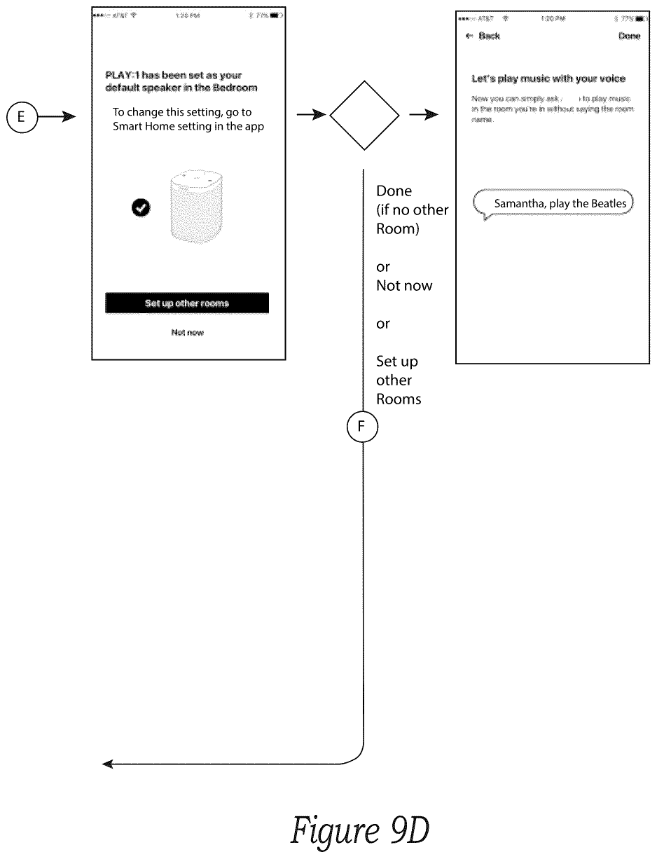

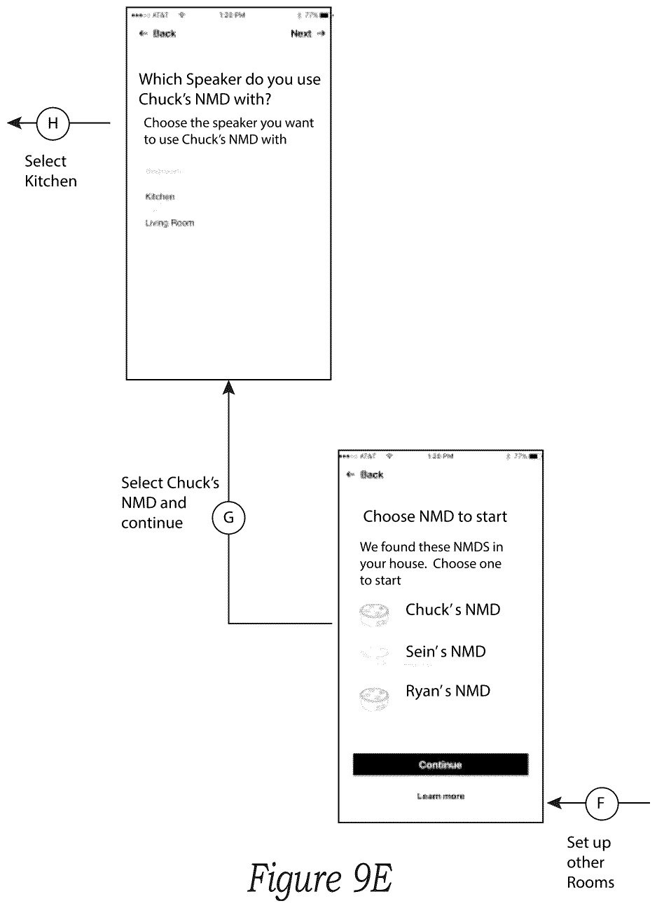

The user interface(s) 440 of a controller device may be configured to facilitate user access and control of the media playback system 100, by providing controller interface(s) such as the controller interfaces 440a and 440b shown in FIGS. 4B and 4C, respectively, which may be referred to collectively as the controller interface 440. Referring to FIGS. 4B and 4C together, the controller interface 440 includes a playback control region 442, a playback zone region 443, a playback status region 444, a playback queue region 446, and a sources region 448. The user interface 400 as shown is just one example of a user interface that may be provided on a network device such as the controller device shown in FIG. 3 and accessed by users to control a media playback system such as the media playback system 100. Other user interfaces of varying formats, styles, and interactive sequences may alternatively be implemented on one or more network devices to provide comparable control access to a media playback system. In various examples, one or both of the controller interfaces 440a and 440b may include a soft button 441 or other touch feature that, when selected or otherwise interacted with, enables access of an interface, such as one of user interfaces described below with reference to FIGS. 8A-9E, that includes icons or other suitable controls to set-up and/or modify a Device Space, as discussed above.

The playback control region 442 (FIG. 4B) may include selectable (e.g., by way of touch or by using a cursor) icons or other controls to cause playback devices in a selected playback zone or zone group to play or pause, fast forward, rewind, skip to next, skip to previous, enter/exit shuffle mode, enter/exit repeat mode, enter/exit cross fade mode. The playback control region 442 may also include selectable icons to modify equalization settings, and playback volume, among other possibilities.

The playback zone region 443 (FIG. 4C) may include representations of playback zones within the media playback system 100. The playback zones regions may also include representation of zone groups, such as the Dining Room+Kitchen zone group, as shown. In some examples, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the user interface 400 are also possible. The representations of playback zones in the playback zone region 443 (FIG. 4C) may be dynamically updated as playback zone or zone group configurations are modified.

The playback status region 444 (FIG. 4B) may include graphical representations of audio content that is presently being played, previously played, or scheduled to play next in the selected playback zone or zone group. The selected playback zone or zone group may be visually distinguished on the user interface, such as within the playback zone region 443 and/or the playback status region 444. The graphical representations may include track title, artist name, album name, album year, track length, and other relevant information that may be useful for the user to know when controlling the media playback system via the user interface 440.

The playback queue region 446 may include graphical representations of audio content in a playback queue associated with the selected playback zone or zone group. In some examples, each playback zone or zone group may be associated with a playback queue containing information corresponding to zero or more audio items for playback by the playback zone or zone group. For instance, each audio item in the playback queue may include a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative example, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

With reference still to FIGS. 4B and 4C, the graphical representations of audio content in the playback queue region 446 (FIG. 4C) may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 448 may include graphical representations of selectable audio content sources and selectable voice assistants associated with a corresponding VAS. The VASes may be selectively assigned. In some examples, multiple VASes, such as AMAZON's ALEXA® and another voice service, may be invokable by the same network microphone device. In some examples, a user may assign a VAS exclusively to one or more network microphone devices. For example, a user may assign the first VAS 160 to one or both of the NMDs 102a and 102b in the Living Room shown in FIG. 1, and a second VAS to the NMD 103f in the Kitchen. Other examples are possible.

d. Example Audio Content Sources

The audio sources in the sources region 448 may be audio content sources from which audio content may be retrieved and played by the selected playback zone or zone group. One or more playback devices in a zone or zone group may be configured to retrieve playback audio content (e.g., according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a controller device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some examples, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

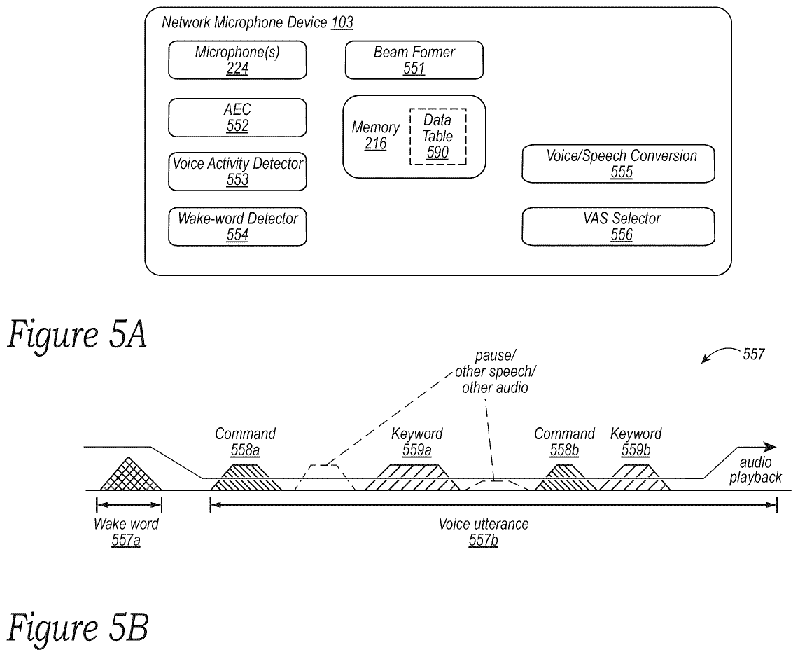

e. Example Network Microphone Devices
FIG. 5A is a functional block diagram showing additional features of one or more of the NMDs 103 in accordance with aspects of the disclosure. The network microphone device shown in FIG. 5A may include components that are generally similar to certain components of network microphone devices described above, such as the processor 212 (FIG. 1), network interface 230 (FIG. 2A), microphone(s) 224, and the memory 216. Although not shown for purposes of clarity, a network microphone device may include other components, such as speakers, amplifiers, signal processors, as discussed above.

The microphone(s) 224 may be a plurality of microphones arranged to detect sound in the environment of the network microphone device. In one example, the microphone(s) 224 may be arranged to detect audio from one or more directions relative to the network microphone device. The microphone(s) 224 may be sensitive to a portion of a frequency range. In one example, a first subset of the microphone(s) 224 may be sensitive to a first frequency range, while a second subset of the microphone(s) 224 may be sensitive to a second frequency range. The microphone(s) 224 may further be arranged to capture location information of an audio source (e.g., voice, audible sound) and/or to assist in filtering background noise. Notably, in some examples the microphone(s) 224 may have a single microphone rather than a plurality of microphones.

A network microphone device may further include beam former components 551, acoustic echo cancellation (AEC) components 552, voice activity detector components 553, wake word detector components 554, speech/text conversion components 555 (e.g., voice-to-text and text-to-voice), and VAS selector components 556. In various examples, one or more of the components 551-556 may be a subcomponent of the processor 512.

The beamforming and AEC components 551 and 552 are configured to detect an audio signal and determine aspects of voice input within the detect audio, such as the direction, amplitude, frequency spectrum, etc. For example, the beamforming and AEC components 551 and 552 may be used in a process to determine an approximate distance between a network microphone device and a user speaking to the network microphone device. In another example, a network microphone device may detective a relative proximity of a user to another network microphone device in a media playback system.

The voice activity detector activity components 553 are configured to work closely with the beamforming and AEC components 551 and 552 to capture sound from directions where voice activity is detected. Potential speech directions can be identified by monitoring metrics which distinguish speech from other sounds. Such metrics can include, for example, energy within the speech band relative to background noise and entropy within the speech band, which is measure of spectral structure. Speech typically has a lower entropy than most common background noise.

The wake-word detector components 554 are configured to monitor and analyze received audio to determine if any wake words are present in the audio. The wake-word detector components 554 may analyze the received audio using a wake word detection algorithm. If the wake-word detector 554 detects a wake word, a network microphone device may process voice input contained in the received audio. Example wake word detection algorithms accept audio as input and provide an indication of whether a wake word is present in the audio. Many first-and third-party wake word detection algorithms are known and commercially available. For instance, operators of a voice service may make their algorithm available for use in third-party devices. Alternatively, an algorithm may be trained to detect certain wake-words.

In some examples, the wake-word detector 554 runs multiple wake word detections algorithms on the received audio simultaneously (or substantially simultaneously). As noted above, different voice services (e.g. AMAZON's ALEXA®, APPLE's SIRI®, or MICROSOFT's CORTANA®) each use a different wake word for invoking their respective voice service. To support multiple services, the wake word detector 554 may run the received audio through the wake word detection algorithm for each supported voice service in parallel.

The VAS selector components 556 are configured to detect for commands spoken by the user within a voice input. The speech/text conversion components 555 may facilitate processing by converting speech in the voice input to text. In some examples, a network microphone device may include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional VASes, which typically sample from a broad base of users and diverse requests that are not targeted to media playback systems. In various examples, text-to-voice and/or voice-to-text processes may be carried out via a remote computing device configured to provide voice/text conversion services (e.g., web-based services separate from the VAS).

The VAS selector components 556 are also configured to determine if certain command criteria are met for particular command(s) detected in a voice input. Command criteria for a given command in a voice input may be based, for example, on the inclusion of certain keywords within the voice input. A keyword may be, for example, a word in the voice input identifying a particular device or group in the media playback system 100. As used herein, the term “keyword” may refer to a single word (e.g., “Bedroom”) or a group of words (e.g., “the Living Room”).

In addition or alternately, command criteria for given command(s) may involve detection of one or more control state and/or zone state variables in conjunction with detecting the given command(s). Control state variables may include, for example, indicators identifying a level of volume, a queue associated with one or more device(s), and playback state, such as whether devices are playing a queue, paused, etc. Zone state variables may include, for example, indicators identifying which, if any, zone players are grouped. The VAS selector components 556 may store in the memory 216 a set of command information, such as in a data table 590, that contains a listing of commands and associated command criteria, which are described in greater detail below.

In some examples, one or more of the components 551-556 described above can operate in conjunction with the microphone(s) 224 to detect and store a user's voice profile, which may be associated with a user account of the media playback system 100. In some examples, voice profiles may be stored as and/or compared to variables stored in the set of command information 590, as described below. The voice profile may include aspects of the tone or frequency of user's voice and/or other unique aspects of the user such as those described in previously referenced U.S. patent application Ser. No. 15/438,749.

In some examples, one or more of the components 551-556 described above can operate in conjunction with the microphone array 524 to determine the location of a user in the home environment and/or relative to a location of one or more of the NMDs 103. The location or proximity of a user may be detected and compared to a variable stored in the command information 590, as described below. Techniques for determining the location or proximity of a user may include or more techniques disclosed in previously referenced U.S. patent application Ser. No. 15/438,749, U.S. Pat. No. 9,084,058 filed Dec. 29, 2011, and titled “Sound Field Calibration Using Listener Localization,” and U.S. Pat. No. 8,965,033 filed Aug. 31, 2012, and titled “Acoustic Optimization.” U.S. Pat. No. 9,084,058 and U.S. Pat. No. 8,965,033 are incorporated herein by reference in their entirety.

FIG. 5B is a diagram of an example voice input in accordance with aspects of the disclosure. The voice input may be captured by a network microphone device, such as by one or more of the NMDs 103 shown in FIG. 1. The voice input may include a wake word portion 557a and a voice utterance portion 557b (collectively “voice input 557”). In some examples, the wake word 557a can be a known wake word, such as “Alexa,” which is associated with AMAZON's ALEXA®). In other examples, the voice input 557 may not include a wake word.

In some examples, a network microphone device may output an audible and/or visible response upon detection of the wake word portion 557a. Additionally or alternately, a network microphone device may output an audible and/or visible response after processing a voice input and/or a series of voice inputs (e.g., in the case of a multi-turn request).

The voice utterance portion 557b may include, for example, one or more spoken commands 558 (identified individually as a first command 558a and a second command 558b) and one or more spoken keywords 559 (identified individually as a first keyword 559a and a second keyword 559b). In one example, the first command 557a can be a command to play music, such as a specific song, album, playlist, etc. In this example, the keywords 559 may be one or more words identifying one or more zones in which the music is to be played, such as the Living Room and the Dining Room shown in FIG. 1. In some examples, the voice utterance portion 557b can include other information, such as detected pauses (e.g., periods of non-speech) between words spoken by a user, as shown in FIG. 5B. The pauses may demarcate the locations of separate commands, keywords, or other information spoke by the user within the voice utterance portion 557b.

In some examples, the media playback system 100 is configured to temporarily reduce the volume of audio content that it is playing while detecting the wake word portion 557a. The media playback system 100 may restore the volume after processing the voice input 557, as shown in FIG. 5B. Such a process can be referred to as ducking, examples of which are disclosed in previously referenced U.S. patent application Ser. No. 15/438,749.

Spoken commands 558 may include a command to change a listening mode, such as from Lean In mode to Lean Back mode (or vice versa), as discussed above.

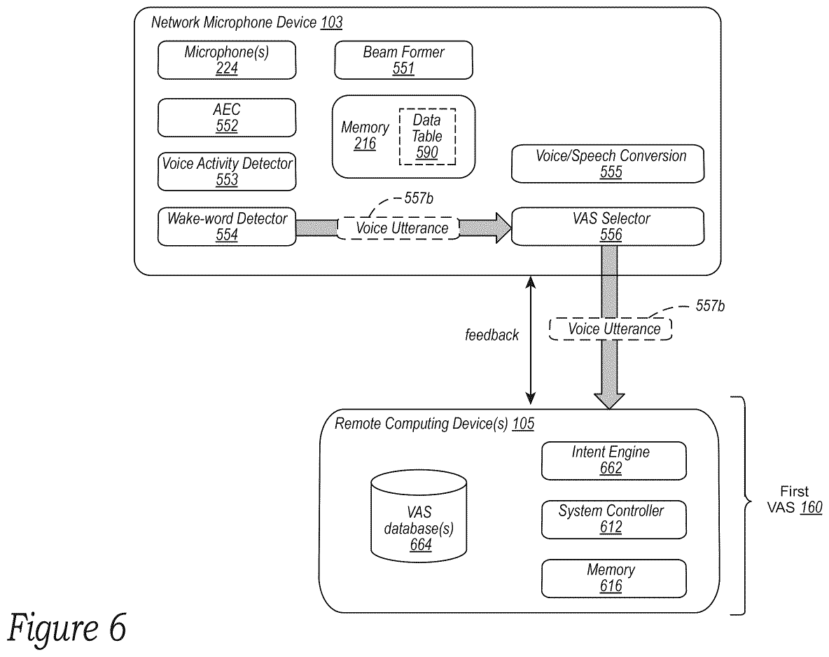

f. Example Network and Remote Computing Systems
FIG. 6 is a functional block diagram showing additional details of the remote computing device(s) 105 in FIG. 1. In various examples, the remote computing device(s) 105 may receive voice inputs from one or more of the NMDs 103 over the WAN 107 shown in FIG. 1. For purposes of illustration, selected communication paths of the voice input 557 (FIG. 5B) are represented by arrows in FIG. 6. In one example, the voice input 557 processed by the remote computing device(s) 105 may include the voice utterance portion 557b (FIG. 5B). In another example, the processed voice input 557 may include both the voice utterance portion 557b and the wake word 557a (FIG. 5B)

The remote computing device(s) 105 includes a system controller 612 comprising one or more processors, an intent engine 602, and a memory 616. The memory 616 may be a tangible computer-readable medium configured to store instructions executable by the system controller 612 and/or one or more of the playback, network microphone, and/or controller devices 102-104.

The intent engine 662 is configured to process a voice input and determine an intent of the input. In some examples, the intent engine 662 may be a subcomponent of the system controller 612. The intent engine 662 may interact with one or more database(s), such as one or more VAS database(s) 664, to process voice inputs. The VAS database(s) 664 may reside in the memory 616 or elsewhere, such as in memory of one or more of the playback, network microphone, and/or controller devices 102-104. In some examples, the VAS database(s) 664 may be updated for adaptive learning and feedback based on the voice input processing. The VAS database(s) 664 may store various user data, analytics, catalogs, and other information for NLU-related and/or other processing.

The remote computing device(s) 105 may exchange various feedback, information, instructions, and/or related data with the various playback, network microphone, and/or controller devices 102-104 of the media playback system 100. Such exchanges may be related to or independent of transmitted messages containing voice inputs. In some examples, the remote computing device(s) 105 and the media playback system 100 may exchange data via communication paths as described herein and/or using a metadata exchange channel as described in previously referenced U.S. patent application Ser. No. 15/438,749.

Processing of a voice input by devices of the media playback system 100 may be carried out at least partially in parallel with processing of the voice input by the remote computing device(s) 105. Additionally, the speech/text conversion components 555 of a network microphone device may convert responses from the remote computing device(s) 105 to speech for audible output via one or more speakers.

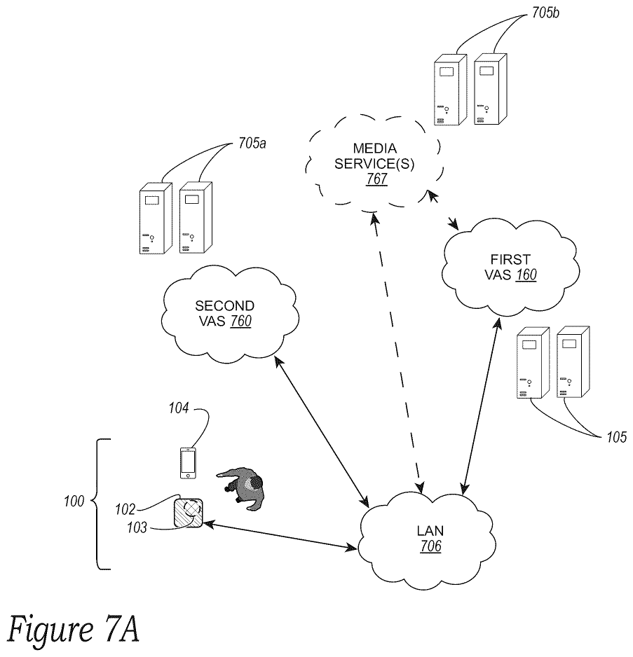

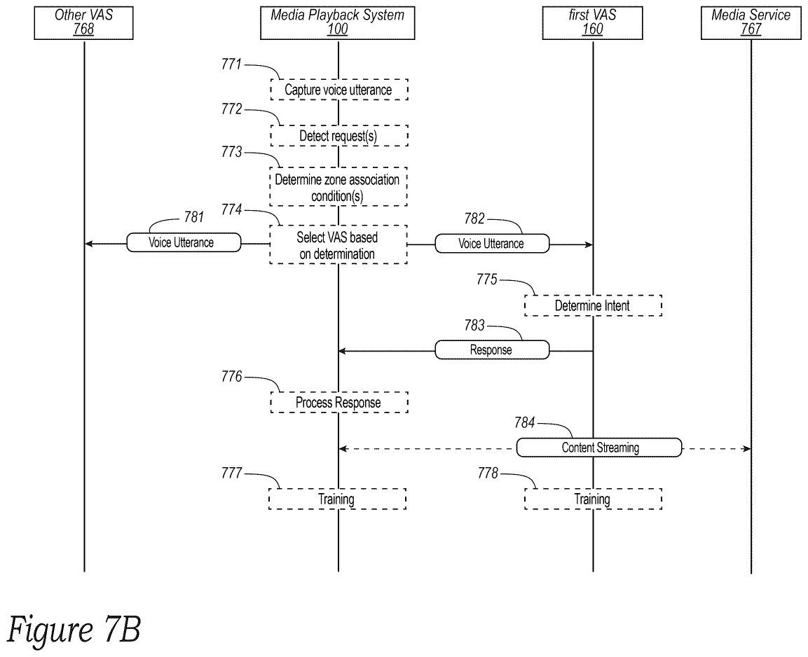

In accordance with various examples of the present disclosure, the remote computing device(s) 105 carry out functions of the first VAS 160 for the media playback system 100. FIG. 7A is schematic diagram of an example network system 700 that includes the first VAS 160. As shown, the remote computing device(s) 105 are coupled to the media playback system 100 via the WAN 107 (FIG. 1) and/or a LAN 706 connected to the WAN 107. In this way, the various playback, network microphone, and controller devices 102-104 of the media playback system 100 may communicate with the remote computing device(s) 105 to invoke functions of the first VAS 160.

The network system 700 further includes additional first remote computing device(s) 705a (e.g., cloud servers) and second remote computing device(s) 705b (e.g., cloud servers). The second remote computing device(s) 705b may be associated with a media service provider 767, such as SPOTIFY® or PANDORA®. In some examples, the second remote computing device(s) 705b may communicate directly the computing device(s) of the first VAS 160. Additionally or alternately, the second remote computing device(s) 705b may communicate with the media playback system 100 and/or other intervening remote computing device(s).

The first remote computing device(s) 705a may be associated with a second VAS 760. The second VAS 760 may be a traditional VAS provider associated with, e.g., AMAZON's ALEXA®, APPLE's SIRI®, MICROSOFT's CORTANA®, or another VAS provider. Although not shown for purposes of clarity, the network computing system 700 may further include remote computing devices associated with one or more additional VASes, such as additional traditional VASes. In such examples, media playback system 100 may be configured to select the first VAS 160 over the second VAS 760 as well as another VAS.

FIG. 7B is a message flow diagram illustrating various data exchanges in the network computing system 700 of FIG. 7A. The media playback system 100 captures a voice input via a network microphone device (block 771), such as via one or more of the NMDs 103 shown in FIG. 1. The media playback system 100 may select an appropriate VAS, such as the first VAS 160, based on commands and associated command criteria in the set of command information 590 (blocks 771-774).

In some examples, the set of command information may include information corresponding to set-up or modification of a particular Device Space. In some examples, the set of command information may include information corresponding to a particular listening mode (e.g., Lean In or Lean Back) to instruct a set of devices to change into that mode. In related examples, the VAS 160 and/or a local computing device may store information corresponding to user preferences for a particular listening mode, characteristics of playback and/or network microphone devices (e.g., a particular make/model of device, whether the device includes or is associated with an NMD, etc.), and/or other information, such as information identifying particular Device Spaces, devices within a given devices space,, and/or current states of the devices within a given Device Space.

In the example shown in FIG. 7B, the first VAS 160 is selected, and the media playback system 100 transmits one or more messages 782 (e.g., packets) containing the voice input to the VAS 160. The media playback system 100 may concurrently transmit other information to the VAS 160 with the message(s) 782. For example, the media playback system 100 may transmit data over a metadata channel, as described in previously referenced U.S. patent application Ser. No. 15/131,244.

The first VAS 160 may process the voice input in the message(s) 782 to determine intent (block 775). Based on the intent, the VAS 160 may send one or more response messages 783 (e.g., packets) to the media playback system 100. In some instances, the response message(s) 783 may include a payload that directs one or more of the devices of the media playback system 100 to execute instructions (block 776). For example, the instructions may direct the media playback system 100 to play back media content, group devices, and/or perform other functions described below. In addition or alternately, the response message(s) 783 from the VAS 160 may include a payload with a request for more information, such as in the case of multi-turn commands.

In some examples, the payload of the response message may cause the media playback system to instantiate a particular listening mode. In some examples, the payload may cause the media playback system to create or modify a Device Space and/or related data structures stored remotely and/or locally by the system.

In some examples, the response message(s) 783 sent from the first VAS 160 may direct the media playback system 100 to request media content, such as audio content, from the media service(s) 667. In other examples, the media playback system 100 may request content independently from the VAS 160. In either case, the media playback system 100 may exchange messages for receiving content, such as via a media stream 784 comprising, e.g., audio content.

In some examples, the media playback system 100 may receive audio content from a line-in interface on a playback, network microphone, or other device over a local area network via a network interface. Example audio content includes one or more audio tracks, a talk show, a film, a television show, a podcast, an Internet streaming video, among many possible other forms of audio content. The audio content may be accompanied by video (e.g., an audio track of a video) or the audio content may be content that is unaccompanied by video.

In some examples, the media playback system 100 and/or the first VAS 160 may use voice inputs that result in successful (or unsuccessful) responses from the VAS for training and adaptive training and learning (blocks 777 and 778). Training and adaptive learning may enhance the accuracy of voice processing by the media playback system 100 and or the first VAS 160. In one example, the intent engine 662 (FIG. 6) may update and maintain training learning data in the VAS database(s) 664 for one or more user accounts associated with the media playback system 100.

### III. Device Spaces

FIG. 8A is an example method 800 for setting up and configuring Device Spaces in a media playback system according to some examples. FIGS. 8B-8F show various examples of forming a Device Space comprising certain playback and network microphone devices shown in FIG. 1.

Referring first to FIG. 8A, method 800 begins at block 802 when the system receives an instruction to set up a Device Space. In some examples, a user may set up a Device Space using a controller device, such as one of the controller devices 104 shown in FIG. 1. As an example, FIG. 8B shows a controller device with a user interface 840a that prompts a user to set up a Device Space. At block 804, method 800 proceeds to create a Device Space. Creating a Device Space may include storing associations and characteristics of the devices in a Device Space within a data table or other data structure, such as the data table 161 described above.

In some examples, Device Spaces include a set of playback and network devices that are mutually exclusive from the playback and network devices of other Device Spaces. For example, a Device Space including the bonded Living Room devices and the Balcony devices shown in FIG. 1 might not be configured to add the Dining Room device to the Space if the Dining Room device already belongs to another Device Space. As described below, via user input to a user interface, a user may remove a device from a Device Space so that the device is available to be configured into another Device Space.

Alternatively, in another example, Device Spaces are not mutually exclusive. As an example of one such implementation, the Front Area shown in FIG. 3B may be configured as one Device Space and the Back Area may be configured as another Device Space that shares the Bathroom playback device with the Front Area.

At blocks 804 and 805, method 800 proceeds to assign an NMD to the selected Device Space. As an example, a user interface 840b shown in FIG. 8B indicates that the Island device (FIG. 1), the Front device (FIG. 1), and the Right device (FIG. 1) are available to be assigned as an NMD to a Device Space. Information identifying NMDs within a system may be stored within a data table or other data structure, such as the data table 161 described above.

Via user input, such as a touch-selection, a user may select one of the available NMDs to assign into the selected Device Space. In one example, the Island Device is selected. User interface 840c shown in FIG. 8C indicates that the Island Device has been selected for assignment to the Device Space.

The user interface 840c further informs a user that a visible indicator has been displayed on the selected Island device to confirm the selected NMD. As discussed above, visual and/or audible indicators can facilitate forming Device Spaces. Such indicators may be particularly helpful in systems that include multiple devices, as individual devices may be visibly similar (e.g., the same or similar models) or otherwise difficult to identify or single out using a controller device alone.

Referring back to FIG. 8A, method 800 proceeds to blocks 806 and 807 to assign a playback device to the selected Device Space. As an example, a user interface 840d shown in FIG. 8C shows that the Dining Room, the Kitchen, and the Living Room playback devices are available for assignment to the selected Device Space. Notably, the user interface 840d displaying the available playback devices shows the bonded Living Room as a single device even though that bonded zone is includes the separate Front, Left, and Right playback devices, while the user interface 840b (FIG. 8B) displaying NMDs shows the Front and Right NMDs individually. Such differentiation between NMDs that function individually and playback devices that operate as a functional unit may help to simplify set-up and/or provide visual feedback to a user on how the devices will function when configured within the Device Space.

Method 800 further includes designating the assigned playback device as a default playback device of an NMD of the selected zone, as shown at block 809. In some examples, one or more playback devices in a given Device Space might not be designated as default playback device for an NMD. In these and other examples, playback devices may be dynamically designated depending on the listening mode (e.g., lean-in or lean-out listening modes), as discussed above in connection with FIGS. 10A, 10B, and 10C.

In some examples, additional playback and network devices may be assigned to the selected Device Space or another Device Space. For example, at block 810, method 800 may prompt the user to add other devices to the first Device Space. As an example, FIG. 8E show a user interface 840e that prompts a user to add or modify a Device Space, and additional interfaces 840f and 840g may prompt for selection of the remaining playback and network microphone devices, respectively. In some implementations, only one playback device and one NMD may be assigned to a Device Space at any given time.

If a network microphone device has already been assigned to another Device Space, the method 800 may involve removing the NMD from the other Device Space so that it can be assigned to the selected Device Space, as shown at block 812 and in FIG. 8D. In some instances, a user interface may be presented to a user identifying that a network microphone device is part of a different Device Space. For example, interface 840g in FIG. 8F shows the Island NMD as grayed out after it becomes part of the Device Space described above, indicating that the Island NMD is already part of a Device Space.

If a playback device has already been assigned to another Device Space, the method 800 involves removing the playback device from the other Device Space, as shown at block 814 and in FIG. 8D. In some instances, an interface may be presented to a user identifying that a playback device is part of a different Device Space. For example, interface 840f in FIG. 8F shows the Bedroom device as grayed out after it becomes part of the Device Space using the process described above. In some examples, a user may be guided through various user interface (not shown) to remove a selected playback device and/or NMD from a Device Space.

In some examples, creating a Device Space may include automatically naming the first Device Space based on a name associated with the at least one playback device, a group of playback devices comprising the at least one playback device, or a bonded pair or bonded group of playback devices comprising the at least one playback device. In accordance with naming conventions of playback zones, such a name may reflect the physical location of the Device Space within a household. For example, the above Device Space comprising the Island and the Dining Room may be named “Dining Room.” As another example, a Device Space comprising the bonded Living Room devices may be named “Living Room.” Naming Device Spaces based on playback device assignments may facilitate user and system recognition of Device Spaces that have been formed. Other naming conventions, however, are possible.

FIGS. 9A-9E are similar to FIGS. 8B-8F and show further examples of forming a Device Space comprising certain playback and network microphone devices in accordance with aspects of the disclosure.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the forgoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A first playback device comprising:
a first network microphone device (NMD);
at least one first microphone;
at least one audio transducer;
a network interface;
at least one processor;
a housing carrying the at least one first microphone, the at least one audio transducer, the network interface, and the at least one processor; and
at least one non-transitory computer-readable medium comprising program instructions that are executable by the at least one processor such that the first playback device is configured to:
receive a command to group multiple playback devices, the multiple playback devices including two or more playback devices comprising respective NMDs, wherein the two or more playback devices include the first playback device and a second playback device comprising a second NMD and at least one second microphone;
according to the received command, form a synchrony group that includes the two or more playback devices;
configure a voice interaction NMD for the synchrony group, wherein the program instructions that are executable by the at least one processor such that the first playback device is configured to configure the voice interaction NMD for the synchrony group comprise program instructions that are executable by the at least one processor such that the first playback device is configured to:
select a NMD from among the two or more playback devices comprising respective NMDs as the voice interaction NMD; and
disable each NMD in the synchrony group other than the selected NMD.

2. The first playback device of claim 1, wherein the program instructions that are executable by the at least one processor such that the first playback device is configured to select the NMD from among the two or more playback devices comprising respective NMDs comprise program instructions that are executable by the at least one processor such that the first playback device is configured to:
select the first NMD as the voice interaction NMD, wherein the program instructions that are executable by the at least one processor such that the first playback device is configured to disable each NMD in the group other than the selected NMD comprise program instructions that are executable by the at least one processor such that the first playback device is configured to:
disable the second NMD.

3. The first playback device of claim 2, wherein the program instructions that are executable by the at least one processor such that the first playback device is configured to disable the second NMD comprise program instructions that are executable by the at least one processor such that the first playback device is configured to:
disable, via the network interface, the at least one second microphone of the second playback device.

4. The first playback device of claim 2, wherein the first playback device is assigned a first role within the synchrony group to play at least one first audio channel, wherein the second playback device is assigned a second role within the synchrony group to play at least one second audio channel, and wherein the program instructions that are executable by the at least one processor such that the first playback device is configured to select the first NMD as the voice interaction NMD comprise program instructions that are executable by the at least one processor such that the first playback device is configured to:
select the first NMD as the voice interaction NMD based on assignment of the first playback device to the first role.

5. The first playback device of claim 2, wherein the at least one non-transitory computer-readable medium further comprises program instructions that are executable by the at least one processor such that the first playback device is configured to:
receive input data representing a selection of the first playback device, wherein the program instructions that are executable by the at least one processor such that the first playback device is configured to select the first NMD as the voice interaction NMD comprise program instructions that are executable by the at least one processor such that the first playback device is configured to:
select the first NMD as the voice interaction NMD according to the received input data representing a selection of the first playback device.

6. The first playback device of claim 5, wherein the input data comprises voice data, and wherein the program instructions that are executable by the at least one processor such that the first playback device is configured to select the first NMD as the voice interaction NMD comprise program instructions that are executable by the at least one processor such that the first playback device is configured to:
receive, via the at least one first microphone, a voice input comprising the voice data.

7. The first playback device of claim 2, wherein the at least one non-transitory computer-readable medium further comprises program instructions that are executable by the at least one processor such that the first playback device is configured to:
receive, via the at least one first microphone, a voice input;
process the voice input via the first NMD; and
play back a spoken response to the voice input via the at least one audio transducer.

8. The first playback device of claim 7, wherein the voice input comprises a wherein the program instructions that are executable by the at least one processor such that the first playback device is configured to play back the spoken response to the voice input via the at least one audio transducer comprise program instructions that are executable by the at least one processor such that the first playback device is configured to:
play back the spoken response to the voice input via the at least one audio transducer in synchrony with playback of the spoken response by other playback devices in the synchrony group.

9. The first playback device of claim 1, wherein the program instructions that are executable by the at least one processor such that the first playback device is configured to select the NMD from among the two or more playback devices comprising respective NMDs comprise program instructions that are executable by the at least one processor such that the first playback device is configured to:
select the second NMD as the voice interaction NMD, wherein the program instructions that are executable by the at least one processor such that the first playback device is configured to disable each NMD in the group other than the selected NMD comprise program instructions that are executable by the at least one processor such that the first playback device is configured to:
disable the first NMD.

10. The first playback device of claim 9, wherein the program instructions that are executable by the at least one processor such that the first playback device is configured to disable the first NMD comprise program instructions that are executable by the at least one processor such that the first playback device is configured to:
disable the at least one first microphone.

11. A media playback system comprising:
multiple playback devices comprising a first playback device and a second playback device, the first playback device comprising a first network microphone device (NMD) and the second playback device comprising a second NMD;
at least one processor; and
at least one non-transitory computer-readable medium comprising program instructions that are executable by the at least one processor such that the media playback system is configured to:
receive a command to group the multiple playback devices, the multiple playback devices including two or more playback devices comprising respective NMDs, wherein the two or more playback devices include the first playback device and the second playback device;
according to the received command, form a synchrony group that includes the two or more playback devices;
configure a voice interaction NMD for the synchrony group, wherein the program instructions that are executable by the at least one processor such that the media playback system is configured to configure the voice interaction NMD for the synchrony group comprise program instructions that are executable by the at least one processor such that the media playback system is configured to:
select a NMD from among the two or more playback devices comprising respective NMDs as the voice interaction NMD; and
disable each NMD in the synchrony group other than the selected NMD.

12. The media playback system of claim 11, wherein the program instructions that are executable by the at least one processor such that the media playback system is configured to select the NMD from among the two or more playback devices comprising respective NMDs comprise program instructions that are executable by the at least one processor such that the media playback system is configured to:
select the first NMD as the voice interaction NMD, wherein the program instructions that are executable by the at least one processor such that the first playback device is configured to disable each NMD in the group other than the selected NMD comprise program instructions that are executable by the at least one processor such that the first playback device is configured to:
disable the second NMD.

13. The media playback system of claim 12, wherein the first playback device comprises at least one first microphone and the second playback device comprises at least one second microphone, and wherein the program instructions that are executable by the at least one processor such that the first playback device is configured to disable the second NMD comprise program instructions that are executable by the at least one processor such that the media playback system is configured to:
disable, via a network interface of the first playback device, the at least one second microphone of the second playback device.

14. The media playback system of claim 12, wherein the first playback device is assigned a first role within the synchrony group to play at least one first audio channel, wherein the second playback device is assigned a second role within the synchrony group to play at least one second audio channel, and wherein the program instructions that are executable by the at least one processor such that the media playback system is configured to select the first NMD as the voice interaction NMD comprise program instructions that are executable by the at least one processor such that the media playback system is configured to:
select the first NMD as the voice interaction NMD based on assignment of the first playback device to the first role.

15. The media playback system of claim 12, wherein the at least one non-transitory computer-readable medium further comprises program instructions that are executable by the at least one processor such that the media playback system is configured to:
receive input data representing a selection of the first playback device, wherein the program instructions that are executable by the at least one processor such that the media playback system is configured to select the first NMD as the voice interaction NMD comprise program instructions that are executable by the at least one processor such that the media playback system is configured to:
select the first NMD as the voice interaction NMD according to the received input data representing a selection of the first playback device.

16. The media playback system of claim 15, wherein the first playback device comprises at least one first microphone and the second playback device comprises at least one second microphone, wherein the input data comprises voice data, and wherein the program instructions that are executable by the at least one processor such that the media playback system is configured to select the first NMD as the voice interaction NMD comprise program instructions that are executable by the at least one processor such that the media playback system is configured to:
receive, via the at least one first microphone, a voice input comprising the voice data.

17. The media playback system of claim 12, wherein the first playback device comprises at least one first microphone and the second playback device comprises at least one second microphone, wherein the first playback device comprises at least one audio transducer, and wherein the at least one non-transitory computer-readable medium further comprises program instructions that are executable by the at least one processor such that the media playback system is configured to:
receive, via the at least one first microphone, a voice input;
process the voice input via the first NMD; and
play back a spoken response to the voice input via the at least one audio transducer.

18. The media playback system of claim 17, wherein the voice input comprises a wherein the program instructions that are executable by the at least one processor such that the media playback system is configured to play back the spoken response to the voice input via the at least one audio transducer comprise program instructions that are executable by the at least one processor such that the media playback system is configured to:
play back the spoken response to the voice input via the at least one audio transducer in synchrony with playback of the spoken response by other playback devices in the synchrony group.

19. The media playback system of claim 11, wherein the program instructions that are executable by the at least one processor such that the media playback system is configured to select the NMD from among the two or more playback devices comprising respective NMDs comprise program instructions that are executable by the at least one processor such that the media playback system is configured to:
select the second NMD as the voice interaction NMD, wherein the program instructions that are executable by the at least one processor such that the media playback system is configured to disable each NMD in the group other than the selected NMD comprise program instructions that are executable by the at least one processor such that the media playback system is configured to:
disable the first NMD.

20. A method comprising:
receiving a command to group multiple playback devices, the multiple playback devices including two or more playback devices comprising respective network microphone devices (NMD)s, wherein the two or more playback devices include a first playback device comprising a first NMD and a second playback device comprising a second NMD;
according to the received command, forming a synchrony group that includes the two or more playback devices;
configuring a voice interaction NMD for the synchrony group, wherein configuring the voice interaction NMD for the synchrony group comprises:
selecting a NMD from among the two or more playback devices comprising respective NMDs as the voice interaction NMD; and
disabling each NMD in the synchrony group other than the selected NMD.
